(19) United States
(12) Patent Application Publication
(10) Pub. No.: US 2004/0035027 A1
(43) Pub. Date: Feb. 26, 2004

(54) System and method for organized spinning and related processing

(76) Inventors: Victoria I. Pettigrew, Morgan Hill, CA (US); Stephen H. Pettigrew, Morgan Hill, CA (US)

Correspondence Address: SILICON VALLEY INTELLECTUAL PROPERTY GROUP, P.O. BOX 721120, SAN JOSE, CA, 95172-1120, US

(21) Appl. No.: 10/652,463

(22) Filed: Aug. 28, 2003

Related U.S. Application Data
(63) Continuation of application No. 09/902,057, filed on Jul. 9, 2001, now abandoned.

(51) Int. Cl. G09F 1/00

(52) U.S. Cl. 40/124.01

(57) ABSTRACT

A system and method are provided for identifying and tracking fiber and skeins during spinning and related processing. Initially, fiber is identified utilizing a fiber identifier card, and tracked utilizing a fiber tracking register. After spinning, spun fiber in the form of skeins is tracked utilizing a spinning log card. Such skeins are further marked with skein attachments for identification purposes during spinning-related processing, i.e. washing, stretching etc.

### FIELD OF THE INVENTION

The present invention relates to spinning fibers, and more particularly to organizing fibers during spinning and related processing.

### BACKGROUND OF THE INVENTION

In conventional spinning practice, single fibers are spun and used as basic building blocks in the manufacture of the more complex fiber structures. Prior to the spinning process, fibers, which can be of natural or synthetic origin, are processed using various steps including, but not limited to carding, gilling, combing, drawing and roving.

The prepared fiber is then creeled in a spinning frame where it is subjected first to a draft, or attenuation, by which the linear density of the fiber is reduced to a required level, and is then twisted with an amount of twist which depends upon the weight of the fiber and its intended use. The spinning operation is normally carried out on a machine such as a ringframe, a cap-frame or a flyer-frame, in which the rotation of a spindle serves to both insert twist into the fiber and to wind the fiber onto a package carried on the spindle.

In the manufacture of plied fibers (i.e. a two-fold fiber), single fibers are creeled onto a twisting machine such as a ring-twister, where two or more single fibers are creeled for each spindle of the twisting machine. The single fibers are delivered together at a constant speed and are twisted together and wound onto a package by the rotation of the spindle.

Once the fiber has been spun, it can be wound into skeins for storage and transportation purposes. At this point, the fiber is ready for being further processed and/or used to create clothing articles and other consumer goods.

With such vast number of steps associated with spinning fiber, it is very likely that fiber may become disorganized. This, in turn, leads to confusion, frustration, and possible mistakes during the overall process. Such is especially the case when one is dealing with a countless number of fibers from numerous sources which are to be spun in various ways. There is thus a need for techniques of organizing fibers during the fiber preparation and spinning processes to overcome these difficulties.

### DISCLOSURE OF THE INVENTION

A system and method are provided for identifying and tracking fiber and skeins during spinning and related processing. Initially, fiber is identified utilizing a fiber identifier card, and tracked utilizing a fiber tracking register. After spinning, spun fiber in the form of skeins is tracked utilizing a spinning log card. Such skeins are further marked with skein attachments for identification purposes during spinning-related processing, i.e. washing, stretching etc.

In use, the fiber identifier card, the fiber tracking register, the spinning log card, and the skein attachments together serve to organize the fiber and skeins of a spin lot to avoid confusion, frustration, and possible mistakes during the overall spinning and related processes.

These and other advantages of the present invention will become apparent upon reading the following detailed description and studying the various figures of the drawings.

### BRIEF DESCRIPTION OF THE DRAWINGS

The foregoing and other aspects and advantages are better understood from the following detailed description of a preferred embodiment of the invention with reference to the drawings, in which:

FIGS. 1-4 illustrate a process of identifying and tracking fiber and skeins during spinning and related processing.

FIG. 5 illustrates a sample fiber identifier card for identifying the fiber during spinning-related processing.

FIG. 6 illustrates an exemplary fiber tracking register with a plurality of fields for tracking a current fiber along with previous fibers during spinning-related processing.

FIG. 7 illustrates an exemplary spinning log card, in accordance with one embodiment of the present invention.

FIG. 7A illustrates a reverse side of the spinning log card.

FIGS. 8-10 show exemplary skein attachments, in accordance with one embodiment of the present invention.

FIG. 11 illustrates a correlation of the fiber identifiers, spin log identifiers, and skein identifiers among the fiber identifier card, fiber tracking register, spinning log card, and skein attachments.

### DESCRIPTION OF THE PREFERRED EMBODIMENTS

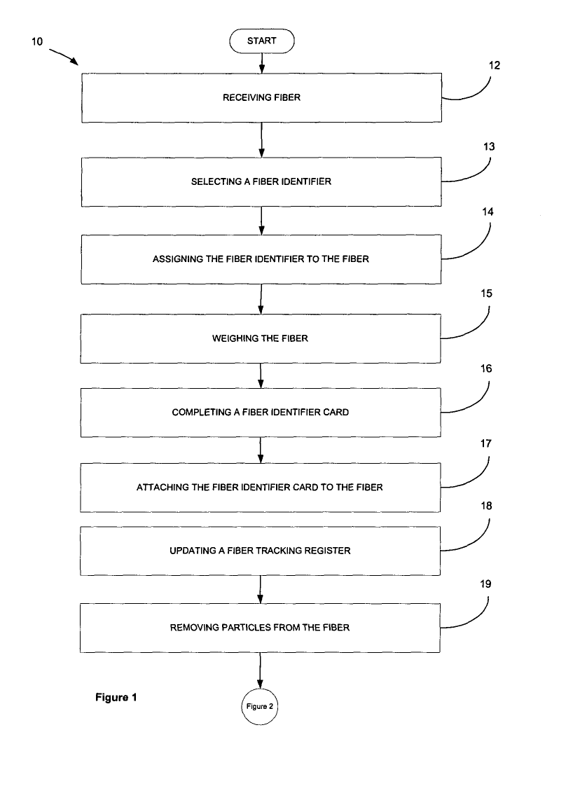

FIGS. 1-4 illustrate a process 10 of identifying and tracking fiber and skeins during spinning and related processing. In operation 12, fiber is received from an origin. The origin of the fiber may include an animal, organic material, synthetic material, and/or any other source per the desire of the user. For example, the fiber may include silk, dog hair, alpaca hair, polyester, and/or any other material.

Once the fiber is received, a fiber identifier is selected in operation 13. In one embodiment, such fiber identifier may succeed previous fiber identifiers associated with previous fibers. As an option, an alphanumeric character may be employed as the fiber identifier. Once selected, the fiber identifier is assigned to fiber in operation 14 after which the fiber is weighed in operation 15. Next, in operation 16, a fiber identifier card is completed for identifying the fiber.

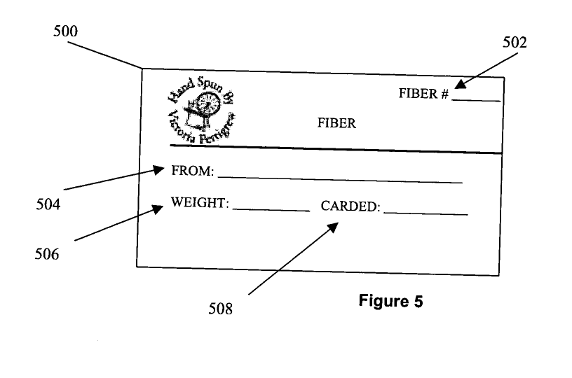

FIG. 5 illustrates a sample fiber identifier card 500 for identifying the fiber during spinning-related processing. The fiber identifier card 500 may have a substantially planar rectangular configuration. Moreover, the fiber identifier card 500 may be constructed from a resilient material such as cardboard or the like. Of course, the fiber identifier card 500 may take any form as long as it serves as an attachment that adequately identifies the fiber.

As shown in FIG. 5, the fiber identifier card 500 includes a fiber identifier field 502 for indicating the fiber identifier (i.e. alphanumeric character) of the fiber that was selected in operation 13 of FIG. 1. Also included is an origin field 504 for identifying the origin of the fiber (i.e. animal, organic/synthetic material, etc.). Such origin field 504 may also be used to identify a manufacturer, store or person from which the fiber was received. Further positioned on the fiber identifier card 500 is a weight field 506 for identifying the weight of the fiber that was determined in operation 15 of FIG. 1. Still yet, the fiber identifier card 500 may include a carded field for identifying a time at which the fiber identifier card 500 was completed, or “filled out,” by the user.

With continuing reference to FIG. 1, it is shown that the procedure 10 continues with the attachment of the fiber identifier card 500 to the associated fiber for identification purposes in operation 17. This may be accomplished in any desired manner. For example, the fiber identifier card 500 may be clipped, adhered, pasted, taped or otherwise attached directly to the fiber. In the alternative, the fiber identifier card 500 may be attached by any desired means to a container (i.e. bag, pouch, etc.) in which the fiber is deposited.

Thereafter, in operation 18, a fiber tracking register is updated for tracking the fiber along with the previous fibers. The fiber tracking register may be updated utilizing information collected during the course of the various operations in FIG. 1.

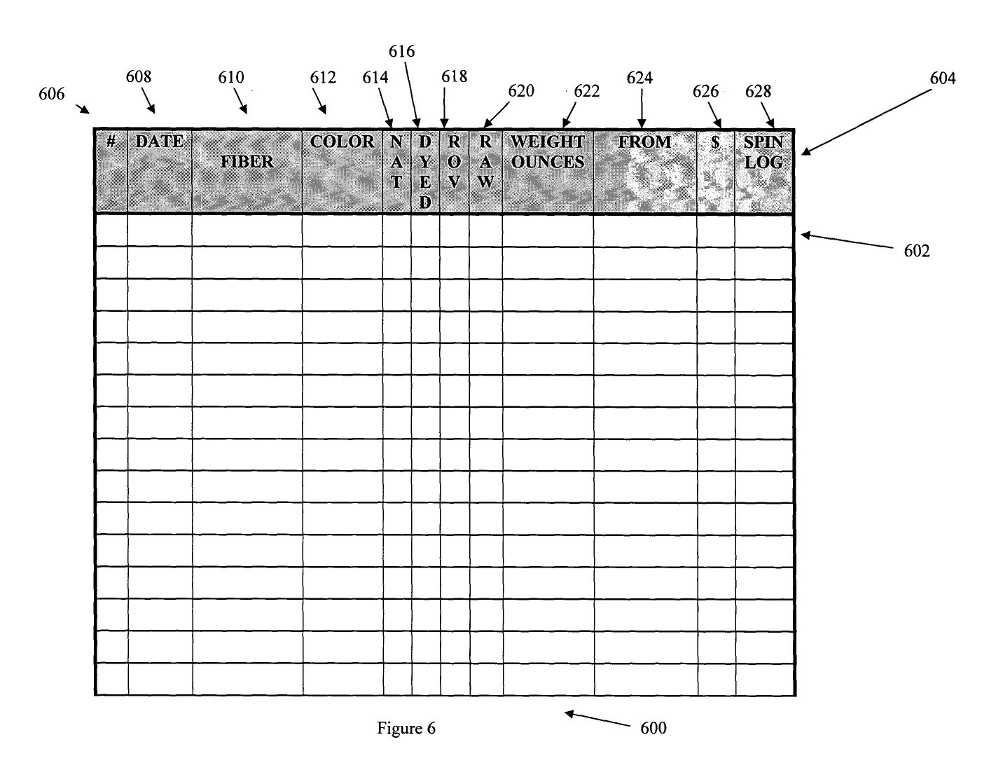

FIG. 6 illustrates an exemplary fiber tracking register 600 with a plurality of fields for tracking a current fiber along with previous fibers during spinning-related processing. As shown, the fiber tracking register 600 includes a plurality of rows 602 and columns 604, where the columns each correspond to a field used to identify and track the fibers. As an option, the fiber tracking register 600 may include a plurality of sheets in the form of a book, where each sheet includes the indicia shown in FIG. 6.

The fiber tracking register 600 includes a fiber identifier field 606 for tracking the fiber identifier of each of the fibers. Such fiber identifier is similar to that which was included in the fiber identifier field 502 of FIG. 5 and assigned in operation 14 of FIG. 1. Ideally, each of the fiber identifier fields 606 is filled from a topmost one of the rows 602 to a bottommost row 602. Also included is a date field 608 for tracking the date that each fiber was received. Still yet, a fiber type field 610 is included for tracking a type of each of the fibers. Such types may include a specific animal, organic material, synthetic material, etc.

The fiber tracking register 600 further includes a color field 612 for tracking a color of each of the fibers. It should be noted that the color of the fiber may vary based on the origin thereof, dying procedures, and/or other miscellaneous factors. As will soon become apparent, the dying procedures are tracked in a subsequent field.

Also included is a natural field 614 for tracking whether each of the fibers is natural. In other words, the present field 614 indicates whether the fiber is a natural fiber, as opposed to a synthetic fiber. Still yet, a dyed field 616 is provided for tracking whether each of the fibers is dyed. Associated therewith is a ROV field 618 for tracking whether each of the fibers was roved. The fiber tracking register 600 also includes a raw field 620 for tracking whether each of the fibers is raw, or unprocessed. It should be noted that fiber may be purchased in a processed form, i.e. cleaned, combed, etc. Each of the foregoing fields 614-620 may be filled with a simple marking (i.e. “x”, check, etc.), while the remaining fields may be filled with descriptive alphanumeric text.

Further provided as a component of the fiber tracking register 600 is a weight field 622 for tracking the weight of each of the fibers. Such information is similar to that which was included in the weight field 506 of FIG. 5 and gathered in operation 15 of FIG. 1. In one embodiment, such weight may be tracked in units of ounces. An origin field 624 for tracking the origin of each of the fibers is also provided. It should be noted that the contents of the origin field 624 may be similar to that of the origin field 504 of the fiber identifier card 500 of the FIG. 5.

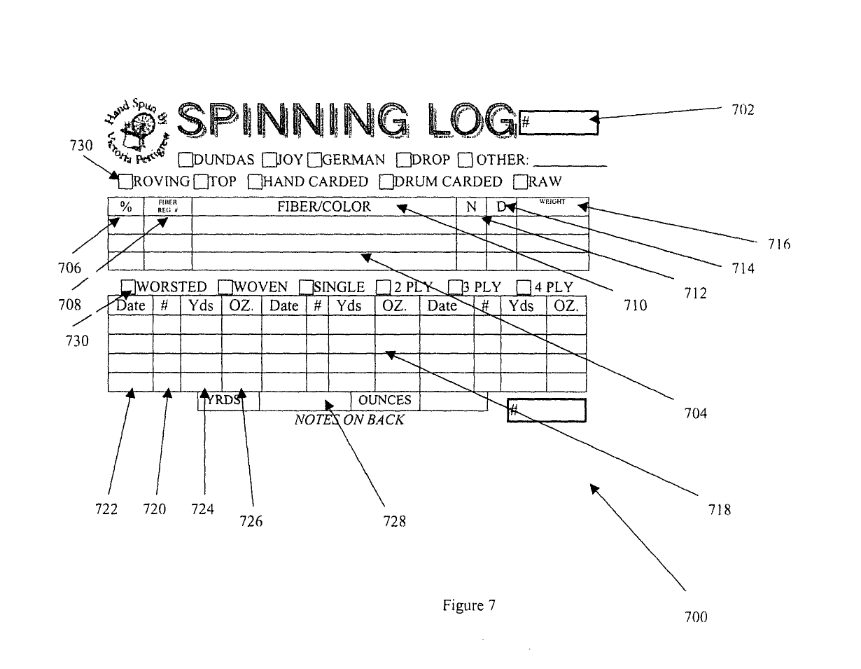

Also included is a price field 626 for tracking a price of each of the fibers. Still yet, a spin log identifier field 628 may be provided for tracking a spin lot in which each of the fibers was used. The manner in which such spin lot is tracked will be set forth in greater detail during reference to FIG. 7.

By this design, the fiber tracking register 600 may be used to track the fibers, and the manner in which they are used in various spin lots.

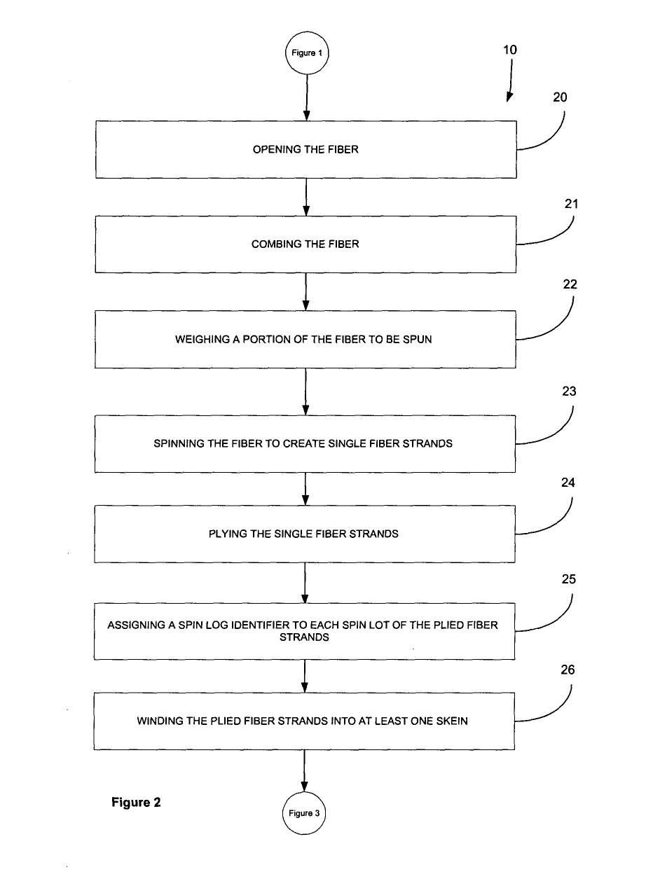

With continuing reference to FIG. 1, particles are removed from the fiber. See operation 19. This may be accomplished utilizing any desired method. For example, a blower may be used to blow the particles from the fiber. In the alternative, the particles may simply be removed by hand. With reference now to FIG. 2, it is shown that the fiber is opened in operation 20 after which it is combed in operation 21. In the context of the present description, combing may be carried out utilizing a conventional comb or similar device to remove knots and/or tangles from the fiber. Moreover, the fiber may be opened by simply spreading the fibers apart.

Next, in operation 22, at least a portion of the fiber that is to be spun is weighed to determine a weight thereof. Such fiber is then spun to create single fiber strands in operation 23. This may be accomplished utilizing any desired means such as a manual or automated spinner, etc. Thereafter, the single fiber strands are plied in operation 24. When plying, two or more strands of the same fiber may be used. In the alternative, different fibers may be used. For example, various combinations may be employed such as alpaca and silk; or alpaca, silk and wool. Further, similar fibers with different colors or different spin textures may be utilized.

Once plied, a spin log identifier may be assigned to each spin lot of the plied fiber strands. See operation 25. As an option, such fiber identifier may succeed spin log identifiers associated with previous spin lots. Moreover, an alphanumeric character may be employed as the spin log identifier, similar to the fiber identifier. It should be noted that the spin log identifier need not necessarily be assigned after operation 24, and, instead, may be assigned at any desired time.

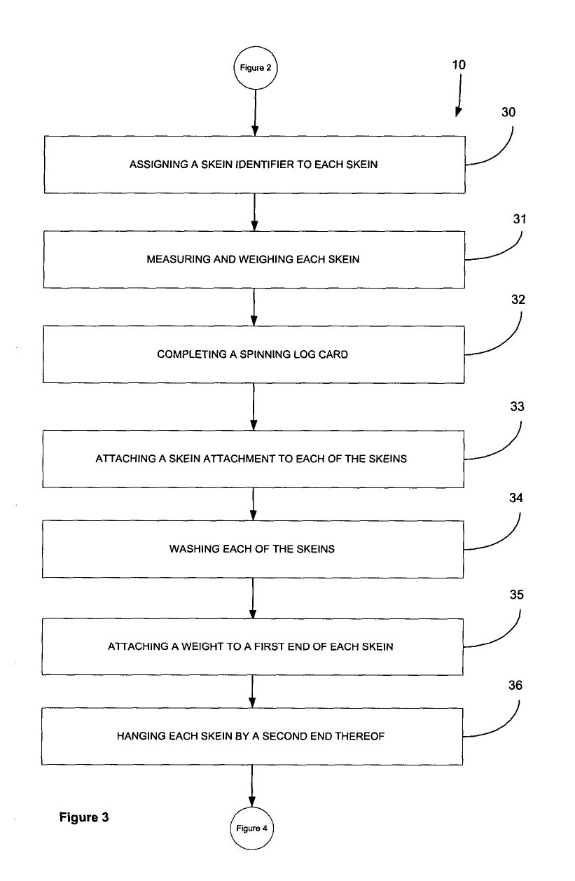

The plied fiber strands are then winded into at least one skein in operation 26. In the context of the present description, a skein may refer to any collection of fiber. With reference now to FIG. 3, a skein identifier is assigned to each skein that results from the spin lot. See operation 30. Similar to the aforementioned identifiers, the skein identifier may succeed skein identifiers associated with other skeins. Moreover, an alphanumeric character may be employed as the skein identifier. Next, in operation 31, each skein is measured and weighed to determine a length and weight thereof, respectively.

Next, a spinning log card is completed for identifying the skeins in operation 32. The spinning log card may be completed utilizing information collected during the course of the various operations in FIGS. 2 and 3.

FIG. 7 illustrates an exemplary spinning log card 700, in accordance with one embodiment of the present invention. The spinning log card 700 may have a substantially planar rectangular configuration. Similar to the fiber identifier card 500, the spinning log card 700 may be constructed from a resilient opaque material such as cardboard or the like. Of course, the spinning log card 700 may take any form as long as it serves as an attachment that adequately identifies the spin lot.

As shown in FIG. 7, the spinning log card 700 includes a spin log identifier field 702 for identifying the spin log identifier of each skein, as assigned in operation 25 of FIG. 2. Still yet, the spinning log card 700 has a plurality of fiber fields 704 each corresponding to one of the fibers used in a spin lot.

Each fiber field 704 includes a percentage sub-field 706 for identifying a percentage of the corresponding fiber used in the spin lot, a fiber identifier sub-field 708 for identifying the fiber identifier of the corresponding fiber (see field 502 of FIG. 5 & field 606 of FIG. 6), a fiber type/color sub-field 710 for identifying at least one of a type and color of the corresponding fiber, a natural sub-field 712 for indicating whether the corresponding fiber is natural, a dyed sub-field 714 for identifying whether the corresponding fiber is dyed, and a weight sub-field 716 for identifying the weight of the corresponding fiber that was used in the particular spin lot.

It should be noted that the weight sub-field 716 is filled with the weight identified in operation 22 of FIG. 2. If the entire portion of the fiber is being used, the weight sub-field 716 will reflect the weight in the weight field 622 of the fiber tracking register 600.

The spinning log card 700 also includes a plurality of skein fields 718 each corresponding to one of the skeins produced in association with the particular spin lot. Each skein field 718 includes a skein identifier sub-field 720 for identifying the skein identifier of the corresponding skein that was assigned in operation 30 of FIG. 3. Each skein field 718 includes a date sub-field 722 for identifying the date that the corresponding skein was winded. Each skein field 718 further has a length and weight sub-field 724 and 726, respectively, for tracking the length and weight of each skein that was identified during operation 31 of FIG. 3. Optionally, a total length and weight field 728 may be included for identifying a total length and weight of all of the skeins of the particular spin lot. Moreover, a reverse side of the spinning log card 700 may be reserved for additional notes associated with the spin lot.

As an option, the spinning log card 700 may include various additional fields 730 for indicating the type of machine used to spin the fiber (i.e. DUNDAS, JOY, GERMAN, DROP, etc.), and whether the fiber was pre-processed by a factory (i.e. ROVING, TOP, HAND CARDED, DRUM CARDED, RAW, OTHER). Still yet, such additional fields 730 may be included for indicating whether the plied fibers are WORSTED, WOVEN, SINGLE PLY, DOUBLE PLY, TRIPLE PLY, etc.

FIG. 7A illustrates a reverse side of the spinning log card 700. As shown, the spinning log card 700 may include a pouch 750 constructed from a transparent material with an opening 752 along a top edge thereof. Such pouch 750 is thus suitable for storing samples 754 of the various fibers identified in the fields of the spinning log card 700.

Next, a skein attachment is attached to each of the skeins in operation 33 of FIG. 3. When handling multiple skeins, confusion may arise as to the identity of the skeins. The skein attachments serve to identify the skeins during spinning-related processing.

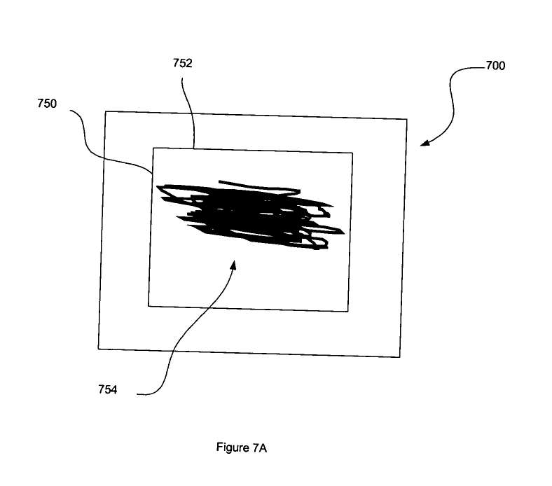

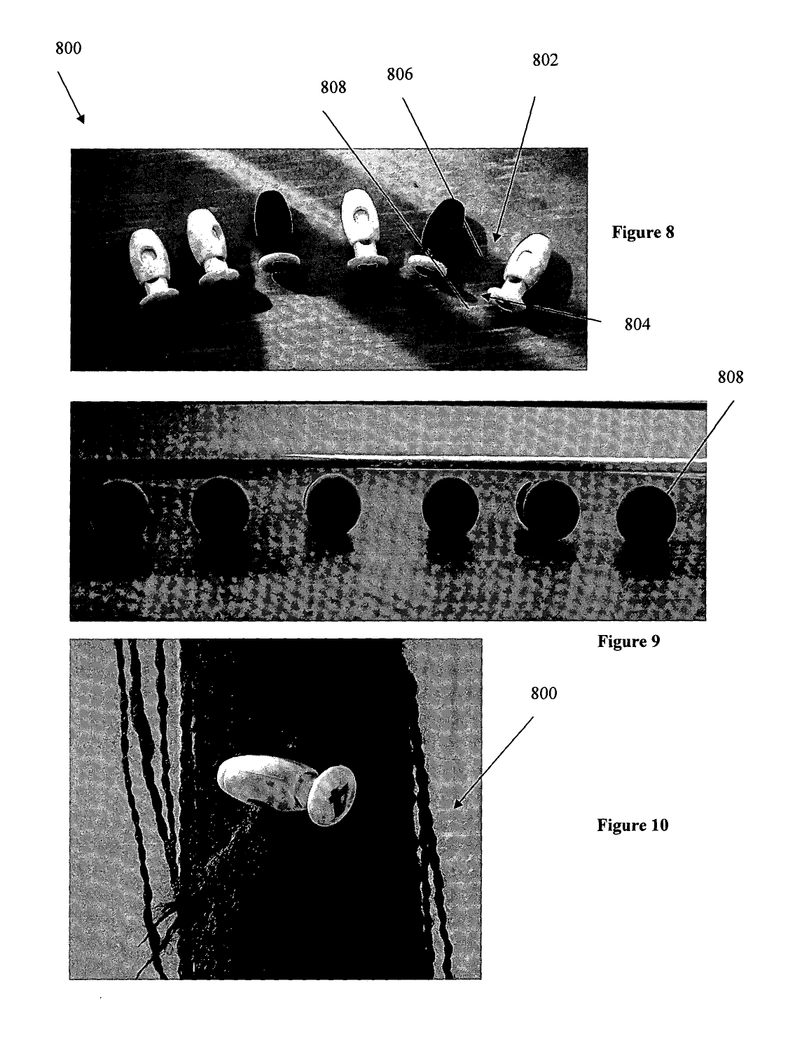

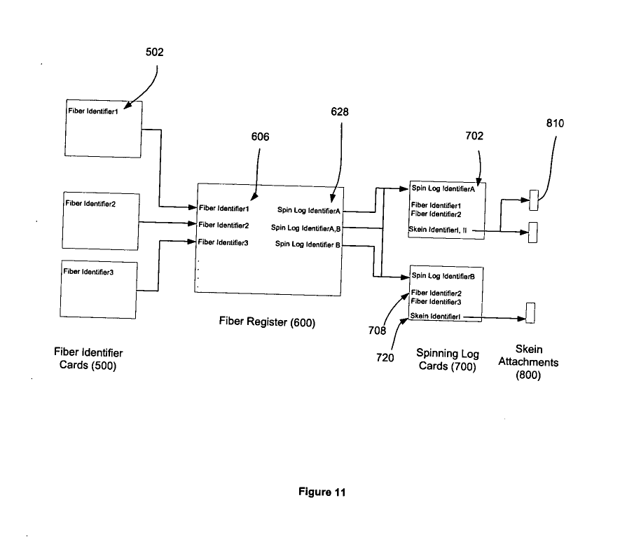

FIGS. 8-10 show exemplary skein attachments 800 that may be used in operation 33 of FIG. 3. It should be noted that the skein attachment 800 may take any form (i.e. clip, button, etc.) capable of being attached to the skeins for identification purposes.

In one embodiment, each skein attachment 800 may include a female portion 802 with a substantially hollow cylindrical configuration. Such female portion 802 includes a first closed circular face, a second open circular face, and a tubular body formed therebetween. Such tubular body includes a pair of aligned apertures 806 formed on diametrically opposed sides of the female portion 802 at a central extent thereof.

Associated therewith is a male portion 804 with a substantially solid cylindrical configuration. The male portion 804 of each skein attachment 800 is equipped with a substantially disk-shaped top face 808 having a diameter greater than that of a remaining portion of the male portion 804. A pair of aligned apertures is formed on diametrically opposed sides of the male portion 804 at a central extent thereof. Still yet, one of a plurality of skein identifiers 810 is positioned on the top face of the male portion. It should be noted that such skein identifiers 810 correspond with those found in the skein identifier fields 720 of the spinning log card 700 of FIG. 7.

In use, the male portion 804 of each skein attachment 800 is slidably positioned within the female portion 802. As such, the male portion 804 has a first biased position with the apertures of the female and male portions aligned, and a second unbiased position with the apertures of the female and male portions misaligned. This may be accomplished by positioning a biased spring (not shown) between the female and male portions. By this structure, a plied fiber strand of one of the skeins may be inserted within the apertures when the skein attachment 800 is in the biased position. Once released, the skein attachment 800 reverts to the unbiased position and is firmly attached to the skein. Note FIG. 9.

With continuing reference to FIG. 3, each of the skeins are then washed with the skein attachments thereon. Note operation 34. Once washed, a weight is attached to a first end of each skein so that each skein may be hung by a second end thereof. See operations 35 and 36 of FIG. 3. It should be understood that such washing and stretching may be handled in any desired manner.

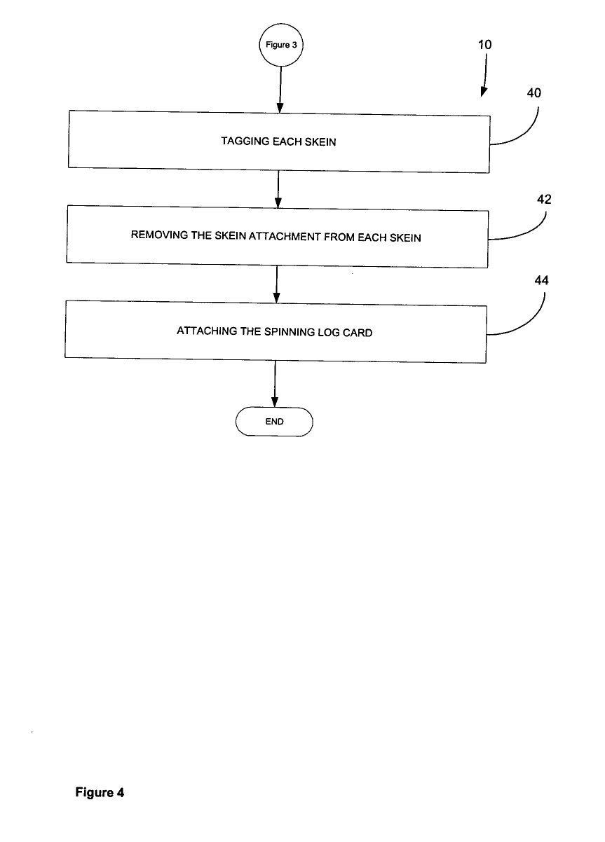

As shown in FIG. 4, the skein attachments 800 may then be used to tag each skein with the correct skein identifier 702. The weight and length of the skeins may also be tagged at this point. This may be accomplished utilizing a sticker, tag or the like (not shown). At this point, the skein attachments 800 have served their purpose and may be removed from each skein. See operation 42. Still yet, each skein may be attached to the appropriate spinning log card 700 for organizing each skein of a spin lot. Note operation 44 of FIG. 4.

As is now apparent, the various identifiers may be used to track the fiber, spin lots, and skeins utilizing the fiber identifier card 500, fiber tracking register 600, spinning log card 700, and skein attachments 800. FIG. 11 illustrates a correlation of the fiber identifiers, spin log identifiers, and skein identifiers among the fiber identifier card 500, fiber tracking register 600, spinning log card 700, and skein attachments 800. Such correlation facilitates the tracking and identifying of the fiber and skeins before, during and after spinning and related processing.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. An apparatus for identifying fiber during spinning, comprising:
a fiber attachment for identifying fiber, the fiber attachment including:
a fiber identifier field for identifying the fiber,
an origin field for identifying an origin of the fiber, and
a weight field for identifying the weight of the fiber;
wherein the fiber attachment is capable of being attached to the fiber for identification purposes.

2. The apparatus as recited in claim 1, wherein the fiber attachment further includes a field for identifying a time at which the fiber attachment was completed.

3. The apparatus as recited in claim 1, wherein the fiber attachment includes a card.

4. An apparatus for tracking fiber during spinning, comprising:
a register including:
a fiber identifier field for tracking a fiber identifier of each of a plurality of fibers,
a weight field for tracking the weight of each of the fibers, and
a spin log identifier field for tracking a spin lot in which each of the fibers is used.

5. The apparatus as recited in claim 4, wherein the register includes a date field for tracking a date that each fiber was received.

6. The apparatus as recited in claim 4, wherein the register includes a fiber type field for tracking a type of each of the fibers.

7. The apparatus as recited in claim 4, wherein the register includes a color field for tracking a color of each of the fibers.

8. The apparatus as recited in claim 4, wherein the register includes a dyed field for tracking whether each of the fibers is dyed.

9. The apparatus as recited in claim 4, wherein the register includes a natural field for tracking whether each of the fibers is natural.

10. The apparatus as recited in claim 4, wherein the register includes a raw field for tracking whether each of the fibers is raw.

11. The apparatus as recited in claim 4, wherein the register includes a price field for tracking a price of each of the fibers.

12. The apparatus as recited in claim 4, wherein the register includes an origin field for tracking the origin of each of the fibers.

13. A method of tracking fiber during spinning, comprising:
receiving fiber;
assigning a fiber identifier to the fiber;
completing a fiber attachment for identifying the fiber, the fiber attachment including a fiber identifier field for identifying the fiber identifier of the fiber; and
updating a register for tracking the fiber along with previous fibers during spinning.

14. An apparatus for identifying skeins, comprising:
a spinning log attachment including:
a plurality of fiber fields each corresponding to one of a plurality of fibers used in a spin lot, and
a plurality of skein fields each corresponding to one of a plurality of skeins produced in the spin lot;
wherein the spinning log attachment is capable of being attached to the skeins produced in the spin lot.

15. The apparatus as recited in claim 14, wherein each fiber field includes a percentage sub-field for identifying a percentage of the corresponding fiber used in the spin lot.

16. The apparatus as recited in claim 14, wherein each fiber field includes a fiber identifier sub-field for identifying a fiber identifier of the corresponding fiber.

17. The apparatus as recited in claim 14, wherein each fiber field includes a fiber type/color sub-field for identifying at least one of a type and color of the corresponding fiber.

18. The apparatus as recited in claim 14, wherein each fiber field includes a natural sub-field for indicating whether the corresponding fiber is natural.

19. The apparatus as recited in claim 14, wherein each fiber field includes a dyed sub-field for identifying whether the corresponding fiber is dyed.

20. The apparatus as recited in claim 14, wherein each fiber field includes a weight sub-field for identifying the weight of the corresponding fiber.

21. The apparatus as recited in claim 14, wherein each skein field includes a date sub-field for identifying a date that the corresponding skein was winded.

22. A method for tracking skeins, comprising:
spinning fiber to create single fiber strands;
plying the single fiber strands;
winding the plied fiber strands into at least one skein;
assigning a skein identifier to the at least one skein;
completing a spinning log attachment for identifying the at least one skein, the spinning log attachment including a skein identifier field for identifying the skein identifier assigned to the at least one skein; and
attaching the spinning log attachment to the at least one skein.

23. The method as recited in claim 22, and further comprising removing particles from the fiber.

24. The method as recited in claim 22, and further comprising opening the fiber.

25. The method as recited in claim 22, and further comprising combing the fiber.

26. The method as recited in claim 22, wherein the spinning log attachment includes a card.

27. A system for tracking skeins during processing, comprising:
a plurality of skeins;
a plurality of attachments each including an attachment portion for attaching to one of the skeins and an identification portion for identifying the skein attached thereto;
wherein the skeins are capable of being washed with the attachments attached thereto for identifying the skeins.

28. The system as recited in claim 27, wherein the attachment portion includes a clip.

29. The system as recited in claim 27, wherein the identification portion of the attachment includes a skein identifier.

30. The system as recited in claim 29, wherein the skein identifier includes a numeral.

31. The system as recited in claim 27, wherein the attachment portion includes a female portion with a substantially hollow cylindrical configuration having a first closed circular face, a second open circular face, and a tubular body with a pair of aligned apertures formed on diametrically opposed sides of the female portion at a central extent thereof; a male portion with a substantially solid cylindrical configuration having a substantially disk-shaped top face with a diameter greater than that of a remaining portion of the male portion, a pair of aligned apertures formed on diametrically opposed sides of the male portion at a central extent thereof, and one of a plurality of skein identifiers positioned on the top face of the male portion; wherein the male portion is slidably positioned within the female portion with a first biased position with the apertures of the female and male portions aligned and a second unbiased position with the apertures of the female and male portions misaligned.

32. A method for tracking skeins during processing, comprising:
spinning fiber to create skeins;
assigning skein identifiers to the skeins;
attaching a skein attachment to each of the skeins, each skein attachment including the corresponding skein identifier;
washing the skeins with the skein attachments thereon;
drying the skeins;
tagging the skeins utilizing the skein identifiers of the skein attachments; and
removing the skein attachments.

33. A method for tracking fiber and skeins during spinning and related processing, comprising:
receiving fiber from an origin;
selecting a fiber identifier which succeeds previous fiber identifiers associated with previous fibers;
assigning the fiber identifier to the fiber;
weighing the fiber to determine a weight thereof,
completing a fiber identifier card for identifying the fiber, the fiber identifier card including a fiber identifier field for identifying the fiber identifier of the fiber, an origin field for identifying the origin of the fiber, a weight field for identifying the weight of the fiber, and a carded field for identifying a time at which the fiber identifier card was completed;
attaching the fiber identifier card to the associated fiber for identification purposes;
updating a fiber tracking register for tracking the fiber along with the previous fibers, the fiber tracking register including a fiber identifier field for tracking the fiber identifier of each of the fibers, a date field for tracking the date that each fiber was received, a fiber type field for tracking a type of each of the fibers, a color field for tracking a color of each of the fibers, a natural field for tracking whether each of the fibers is natural, a dyed field for tracking whether each of the fibers is dyed, a ROV field for tracking whether each of the fibers was roved, a raw field for tracking whether each of the fibers is raw, a weight field for tracking the weight of each of the fibers, an origin field for tracking the origin of each of the fibers, a price field for tracking a price of each of the fibers, and a spin log identifier field for tracking a spin lot in which each of the fibers was used;
removing particles from the fiber;
opening the fiber;
combing the fiber;
weighing a portion of the fiber to determine a weight thereof;
spinning the fiber to create single fiber strands;
plying the single fiber strands;
assigning a spin log identifier to each spin lot of the plied fiber strands;
winding the plied fiber strands into at least one skein;
assigning a skein identifier to each skein;
measuring and weighing each skein to determine a length thereof;
completing a spinning log card for identifying the skeins, the spinning log card including a spin log identifier field for identifying the spin log identifier of each skein; the spinning log card further including a plurality of fiber fields each corresponding to one of the fibers used in a spin lot, each fiber field including a percentage sub-field for identifying a percentage of the corresponding fiber used in the spin lot, a fiber identifier sub-field for identifying the fiber identifier of the corresponding fiber, a fiber type/color sub-field for identfying at least one of a type and color of the corresponding fiber, a natural sub-field for indicating whether the corresponding fiber is natural, a dyed sub-field for identifying whether the corresponding fiber is dyed, and a weight sub-field for identifying the weight of the corresponding fiber; the spinning log card further including a plurality of skein fields each corresponding to one of the produced skeins, each skein field including a skein identifier sub-field for identifying the skein identifier of the corresponding skein, and a date sub-field for identifying the date that the corresponding skein was winded;
attaching a skein attachment to each of the skeins, each skein attachment including a female portion with a substantially hollow cylindrical configuration having a first closed circular face, a second open circular face, and a tubular body with a pair of aligned apertures formed on diametrically opposed sides of the female portion at a central extent thereof; a male portion with a substantially solid cylindrical configuration having a substantially disk-shaped top face with a diameter greater than that of a remaining portion of the male portion, a pair of aligned apertures formed on diametrically opposed sides of the male portion at a central extent thereof, and one of a plurality of skein identifiers positioned on the top face of the male portion; wherein the male portion is slidably positioned within the female portion with a first biased position with the apertures of the female and male portions aligned and a second unbiased position with the apertures of the female and male portions misaligned;
washing each of the skeins with the skein attachments thereon;
attaching a weight to a first end of each skein;
hanging each skein by a second end thereof;
tagging each skein with a skein identifier utilizing the skein attachment;
removing the skein attachment from each skein; and
attaching the spinning log card to the associated skeins for identification purposes.
